(19) United States
(12) Patent Application Publication
(10) Pub. No.: US 2016/0332248 A1
(43) Pub. Date: Nov. 17, 2016

(54) Accessory and Kit for Welding and Cutting Devices

(71) Applicant: Martin Albrecht, Lakewood, OH (US)

(72) Inventor: Martin Albrecht, Lakewood, OH (US)

(21) Appl. No.: 14/867,058

(22) Filed: Sep. 28, 2015

Related U.S. Application Data
(60) Provisional application No. 62/179,614, filed on May 14, 2015.

(51) Int. Cl. B23K 9/28

(52) U.S. Cl. CPC B23K 9/287

(57) ABSTRACT

A welding accessory that allows a welder to easily maintain the proper electrical arc gap between the welding torch and the surface being welded, and that improves the consistency of the shield gas plume by reducing the variation of gap between the shield gas nozzle and the surface being welded while in motion is disclosed. In a preferred embodiment, the welding accessory is comprised of a body portion, a slidable and rotatable repositionable arm; and a wheel attached to one end of said repositionable arm. A kit that comprises the welding accessory of the present invention and other accessories for welding and/or oxy-fuel cutting is also disclosed.

### CROSS-REFERENCE

This application claims priority from Provisional Patent Application Ser. No. 62/179,614 filed on May 14, 2015.

### FIELD OF THE INVENTION

This invention relates to an accessory and a kit for use with a welding and/or cutting device.

### BACKGROUND

Metal inert gas welding, or MIG welding, is well known in the art and is a welding process in which an electric arc forms between a consumable wire electrode and the work piece metal(s), which heats the work piece metal(s), causing them to melt, and join. Along with the wire electrode, a shielding gas feeds through the welding gun, which shields the process from contaminants in the air.

Heretofore, a welder performing a MIG welding operation had to maintain by hand the proper shield gas plume and electric arc gap while also attempting to move the welding device fluidly and continuously to achieve a proper and acceptable welding bead, which could take years of experience to achieve on a consistent basis. Stated differently, heretofore, it has been difficult for novice and even semi-experienced welders to achieve an acceptable bead and weld on a consistent basis, which can be both frustrating and time consuming for a welder or welding technician attempting to learn the craft and lead to inconsistent results.

Oxy-fuel cutting is also a process that is well known in the art and involves using a torch, fuel gases and oxygen to cut metals. More specifically, in oxy-fuel cutting, a torch is used to heat metal to its kindling temperature. A stream of oxygen is then trained on the metal, burning it into a metal oxide that flows out of the kerf as slag. Similar to MIG welding, heretofore, it has been difficult for a novice welder or welding technician to make precision cuts using an oxy-fuel torch due to the need to continuously and fluidly move the cutting torch along the piece of metal being cut.

Consequently, there is a long felt need in the art for a welding accessory that allows the welder to easily maintain the proper electrical arc gap between the torch and the metal surface, and that improves consistency of the shield gas plume by reducing the variation of gap between the shield gas nozzle and the metal surface while in motion. There is also a long felt need in the art for a welding accessory that improves the consistency of the bead and the weld by providing the welder with a means for more concisely and fluidly moving the torch along a desired weld path. Finally, there is a long felt need in the art for a welding kit that comprises a plurality of welding/cutting accessories that enable the welder to accomplish all of the forgoing objectives in a MIG welding or oxy-fuel cutting operation, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is a welding accessory device for: (i) enabling a welder user to easily maintain the proper electrical arc gap between the welding torch and the metal surface, and that improves consistency of the shield gas plume by reducing the variation of gap between the shield gas nozzle and the metal surface while in motion; and (ii) that improves the consistency of the bead and the weld by providing the welder with a means for more concisely and fluidly moving the torch along a desired weld or cutting path.

In a preferred embodiment of the present invention, the welding accessory device comprises a body portion, a repositionable arm having a first end and a second end, and a rotatable wheel positioned along said second end of said arm, as described more fully below. Also disclosed is a kit comprised of the above described welding accessory device and other welding/cutting accessories that enable the welder to accomplish all of the forgoing objectives, as well as others, in a MIG welding or oxy-fuel cutting operation, and that is relatively inexpensive to manufacture and safe and easy to use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of one embodiment of the welding accessory device of the present invention securely attached to an end of a MIG welder.

FIG. 2 is a perspective view of the welding accessory device of FIG. 1.

FIG. 3 is an exploded view of the welding accessory device of FIG. 1.

FIG. 4 is a perspective view of one embodiment of an additional accessory device of the kit of the present invention.

FIG. 5 is a perspective view of one embodiment of an additional accessory device of the kit of the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof It may be evident, however, that the innovation can be practiced without these specific details.

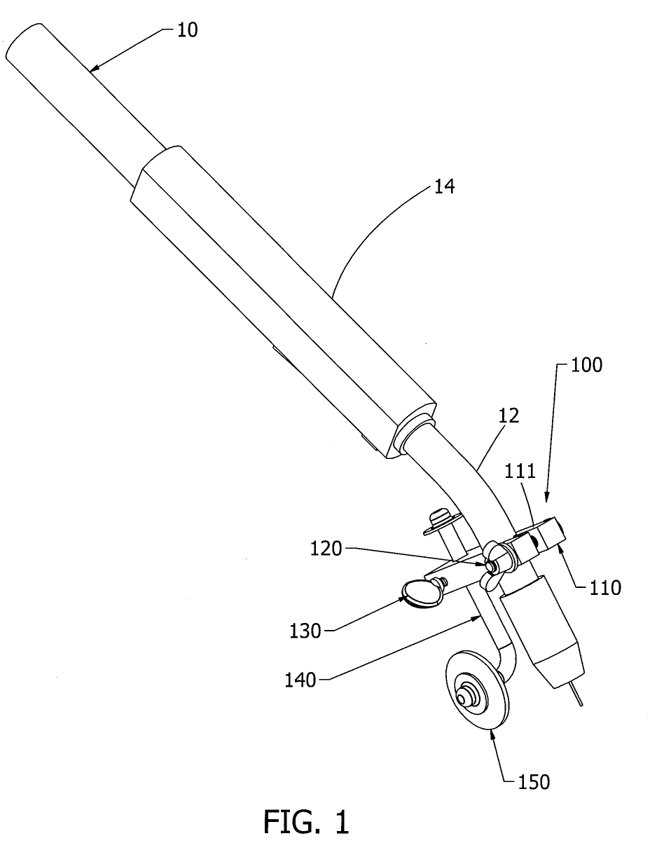

Referring initially to the drawings, FIG. 1 depicts a perspective view of the welding accessory device 100 of the present invention securely attached to a MIG welder 10. More specifically, MIG welder 10 is comprised of a head portion 12 and handle portion 14, and device 100 is removably and repositionably attached to head portion 12.

Device 100 is preferably comprised of a body portion 110, a fastener 120, a set screw 130, an arm portion 140 and a wheel 150. Unless otherwise stated herein, device 100 is preferably comprised of durable materials, such as steel, aluminum, heat resistant plastic or other material capable of being exposed to elevated temperatures due to the proximity of device 100 to MIG welder 10.

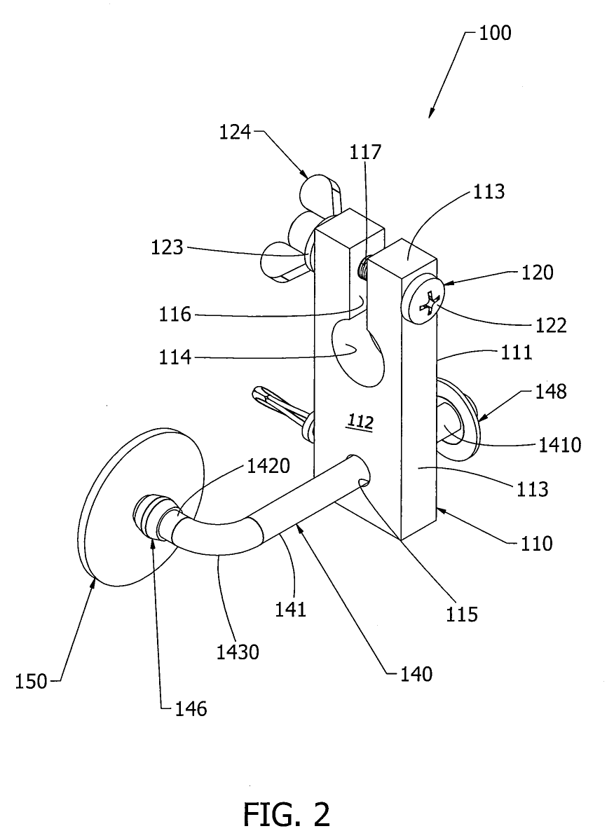

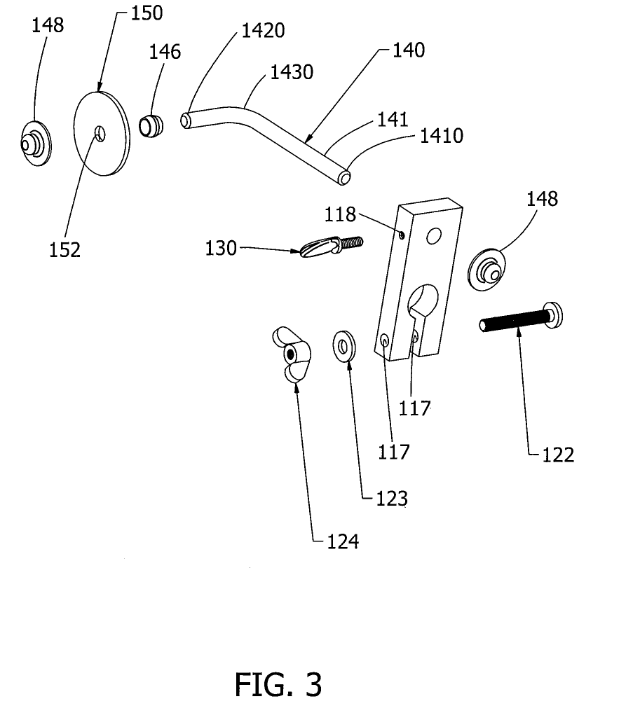

As best shown in FIGS. 2 and 3, body portion 110 is preferably comprised of an inboard surface 111, an outboard surface 112, a plurality of sides 113, a first continuous opening 114, a second continuous opening 115, a slot 116, a fastener opening 117 and an arm fastener opening 118. Inboard surface 111 refers to the surface of body portion 110 facing towards the handle portion 14 of MIG welder 10 when device 100 is properly installed on head portion 12, as shown in FIG. 1. Outboard surface 112 refers to the surface of body portion 110 opposite of inboard surface 111 and facing in the opposite direction of handle portion 14 of MIG welder 10 when device 100 is properly installed on head portion 12, as shown in FIG. 1.

More specifically, first continuous opening 114 extends between inboard surface 111 and outboard surface 112 and is shaped and sized accordingly to receive head portion 12 of MIG welder 10. Similarly, second continuous opening 115 also extends between inboard surface 111 and outboard surface 112 and is shaped and sized accordingly to receive arm portion 140, as described more fully below. As referenced above, body portion 110 is also preferably comprised of slot 116 that extends between said inboard surface 111 and said outboard surface 112, as well as between first continuous opening 114 and one of said plurality of sides 113, as best shown in FIG. 2. As more fully explained below, the width of slot 116 is adjustable by tightening/loosening fastener 120, and slot 116 is useful for installing/removing device 100 from head portion12 of MIG welder 10.

As best illustrated in FIG. 2, fastener opening 117 preferably extends through body portion 110 from one side 113, across slot 116, to a second opposing side 113 and is sized and shaped accordingly to receive fastener 120, as more fully explained below. In a preferred embodiment of the present invention, fastener opening 117 is not threaded, though it is contemplated that fastener opening 117 could also be threaded without affecting the overall scope of the present invention.

As best illustrated in FIGS. 2 and 3, arm fastener opening 118 is located on a select side 113 of body portion 110 and extends to second continuous opening 115, wherein arm portion 140 typically resides. In a preferred embodiment of the present invention, arm fastener opening 118 is threaded and is sized and shaped accordingly to receive set screw 130, as described more fully below.

Fastener 120 may be any fastener commonly known in the art and is preferably comprised of a threaded screw 122, a washer 123 and a nut 124, such as a wing nut for easy handling. Notwithstanding, as mentioned above, if fastener opening 117 is threaded, washer 123 and nut 124 may be eliminated and fastener 120 may simply be screwed into fastener opening 117. As explained more fully below, fastener 120 is useful for slightly increasing or decreasing the size of first continuous opening 114 and slot 116 to install/remove device 100 from head portion 12 of MIG welder 10, and for removably securing device 100 to head portion 12.

Screw 130 may be any fastener commonly known in the art, but is preferably a set screw. Screw 130 is inserted into arm fastener opening 118 in side 113 of body portion 110 and extends to second continuous opening 115, wherein arm portion 140 typically resides. As explained more fully below, screw 130 is useful for securing arm portion 140 in a desired position relative to body portion 110 and MIG welder 10, both longitudinally and rotatably.

As best shown in FIGS. 2 and 3, arm portion 140 is preferably comprised of an elongated member 141, a block 146, and caps 148. More specifically, elongated member 141 extends through second continuous opening 115, and is comprised of a first end 1410, an opposing second end 1420 and a bend 1430 located along the length of elongated member 141 and between said first end 1410 and said second end 1420. A first cap 148 is attached to said first end 1410 to prevent arm portion 140 from being prematurely removed from second continuous opening 115. Block 146 and a second cap 148 are positioned along and removably attached to said second end 1420 of elongated member 110, with wheel 150 also positioned along the second end 1420 of elongated member 110 between said block 146 and second cap 148, as more fully described below. Block 146 and second cap 148 prevent wheel 150 from being prematurely removed from elongated member 141, but do not prevent the rotation of wheel 150 about elongated member 141.

Wheel 150 may be any wheel commonly known in the art and is comprised of a continuous opening 152 therein for receipt of a portion of elongated member 141. More specifically, wheel 150 is positioned along and rotates about said second end 1420 of elongated member 141 and between block 146 and second cap 148.

It is also contemplated that welding accessory device 100 can be combined with other welding and/or oxy-fuel cutting accessories to form a kit that is useful to both professional and novice welders. More specifically, device 100 may be combined with a cutting wheel device 200 and a torch clamp 300.

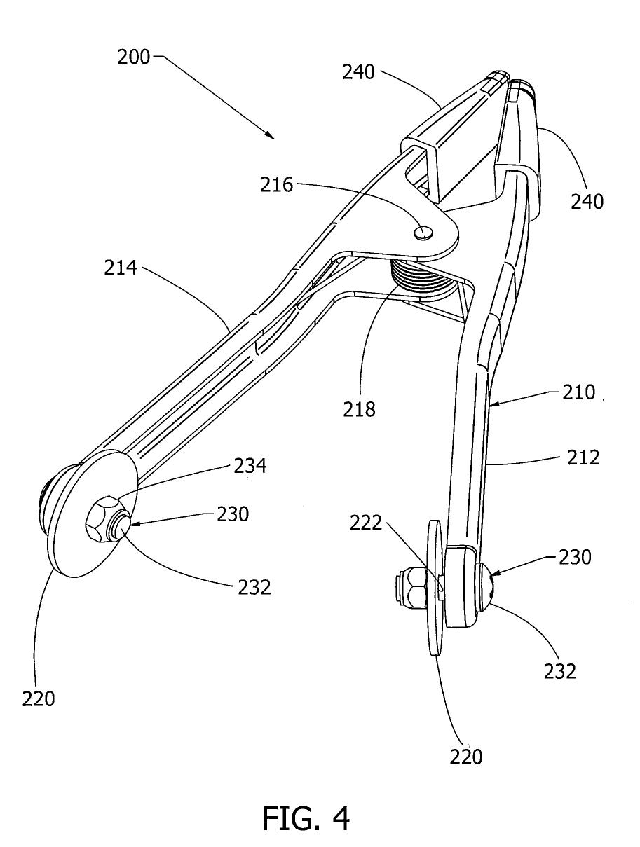

Cutting wheel device 200 is preferably comprised of a clamp 210, wheels 220, fasteners 230 and protective covers 240. More specifically, and as shown in FIG. 4, clamp 210 may be any type of clamp commonly known in the art and is comprised of a first arm 212, a second arm 214, an axle 216 connecting said first arm 212 to said second arm 214, and a spring 218 that is positioned along said axle 216 between said first and second arms 212, 214. Spring 218 is in tension and causes a common end of each of said first arm 212 and said second arm 214 to be in contact with one another (the clamping portion) when said clamp 210 is not in use. A wheel 220 with an opening 222 therein is attached to the opposite end of each of said first arm 212 and said second arm 214 via fasteners 230, as best shown in FIG. 4. Fasteners 230 may be any type of fastener commonly known in the art, but is preferably comprised of a screw 232 that passes through an opening in a respective one of said first arm 212 or second arm 214 as well as opening 222, and one or more nuts 234 to secure wheel 220 to clamp 210. Notwithstanding, each of said wheels 220 rotate about one of said screws 232 and extends beyond the end of said respective first and second arms 212, 214. In this manner, cutting wheel device 200 may be clamped to, for example, an oxy-fuel cutting device (not shown) and rolled along a surface to be cut (also not shown) to provide a precise and consistent cut to said surface. In order to protect said cutting device and the clamping ends of said first arm 212 and said second arm 214, it is also contemplated that a protective cover 240 may be placed on the clamping end of first arm 212 and second arm 214 as shown in FIG. 4.

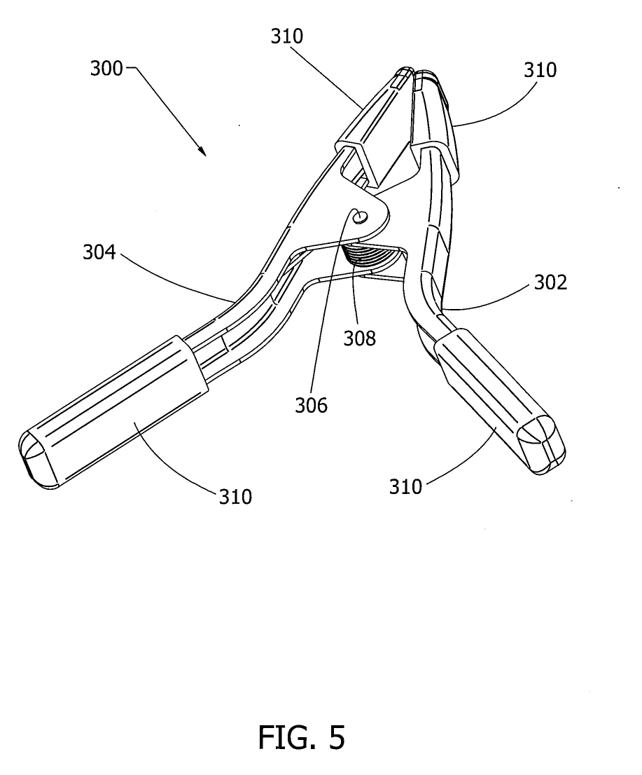

As best shown in FIG. 5, torch clamp 300 may be any type of clamp commonly known in the art and is preferably comprised of a first arm 302, a second arm 304, an axle 306 connecting said first arm 302 to said second arm 304, and a spring 308 that is positioned along said axle 306 between said first and second arms 302, 304. Spring 308 is in tension and causes a common end of each of said first arm 302 and said second arm 304 to be in contact with one another (the clamping portion) when said clamp torch clamp is not in use. Torch clamp 300 may be used to support, for example, an oxy-fuel cutting device or other welding tool above a surface when not in use by clamping said torch clamp 300 to said welding or cutting device and inverting said torch clamp 300 such that the portion of first arm 302 and second arm 304 furthest away from said clamped cutting or welding device (i.e., the non-clamping side of torch clamp 300) may be placed on the resting surface (not shown) with said welding or cutting device positioned above and away from said resting surface. In this manner, a welder or other technician may temporarily store/support said welding or cutting torch without having to shut off the same, thereby temporarily freeing both hands of the welder or technician to perform other tasks.

Having now described the general structure of a preferred embodiment of device 100, as well as the other accessories that comprise the kit, its function will now be described in general terms. A welder or technician (not shown) desiring to improve the consistency of a bead and weld may attach device 100 to a welding device, such as MIG welder 10, by placing the head portion 12 into opening 114, rotating said device 100 about said head portion 12 into a desired position, and tightening fastener 120 to secure device 100 to welding device 10. The welder may then loosen set screw 130 thereby enabling the welder (not shown) to reposition the arm portion 140 (and, therefore, wheel 150) longitudinally and/or rotatably into a desired position relative to head portion 12 of MIG welder 10. Once arm portion 140 and wheel 150 are in a desired position and orientation relative to head portion 12, the welder or other technician may tighten the set screw 130 against said arm portion 140 to lock the same in place. In this manner, a welder or other technician can position said wheel 150 to roll about a surface to be cut or welded in a consistent manner, while also maintaining a relatively constant distance between MIG welder 10 and said surface.

Other variations are also within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A welding accessory device comprising:
a body portion;
a repositionable arm; and
a wheel.

2. The welding accessory device of claim 1 wherein said body portion is comprised of an inboard surface, an outboard surface and a continuous opening extending between said inboard surface and said outboard surface.

3. The welding accessory device of claim 2 wherein said body portion is further comprised of at least one side, a second continuous opening extending between said inboard surface and said outboard surface, and a slot extending between said continuous opening and said at least one side.

4. The welding accessory device of claim 3 wherein said slot also extends between said inboard surface and said outboard surface.

5. The welding accessory device of claim 1 wherein said repositionable arm is comprised of a first end and a second end, and said wheel is positioned along, and rotatable about, said second end.

6. The welding accessory device of claim 2 further comprising a screw, wherein said continuous opening is adjustable in size by turning said screw.

7. The welding accessory device of claim 1 further comprising a block and a cap.

8. The welding accessory device of claim 7, wherein said a block and said cap are attached to said repositionable arm.

9. The welding accessory device of claim 7 further comprising a second cap, wherein said cap is attached to a first end of said repositionable arm and wherein said second cap is attached to a second end of said repositionable arm.

10. The welding accessory device of claim 8, wherein said wheel is position along and rotatable about said repositionable arm between said block and said cap.

11. The welding accessory device of claim 3, wherein said repositionable arm is repositionable longitudinally and rotatably within said second continuous opening.

12. A welding accessory device comprising:
a body portion comprised of a first continuous opening and a second continuous opening;
a repositionable arm positioned in said second continuous opening; and
a wheel attached to and rotatable about said repositionable arm.

13. The welding accessory device of claim 12 wherein said body portion further comprises a slot adjacent to said first continuous opening.

14. The welding accessory device of claim 13 further comprising a screw, wherein said first continuous opening and said slot are adjustable in size by turning said screw.

15. The welding accessory device of claim 12 further comprising a block and a cap, wherein said block and cap are attached to said repositionable arm.

16. The welding accessory device of claim 15, wherein said wheel is positioned along said repositionable arm between said block and said cap.

17. The welding accessory device of claim 12, wherein said repositionable arm is repositionable longitudinally and rotatably within said second continuous opening.

18. A welding accessory kit comprising:
a clamp;
a wheeled clamp; and
a welding device further comprising
a body portion comprised of a first continuous opening and a second continuous opening;
a repositionable arm positioned in said second continuous opening; and
a wheel attached to and rotatable about said repositionable arm.

19. The welding accessory kit of claim 18 wherein said wheeled clamp is comprised of a clamping device, a first wheel and a second wheel, and further wherein said clamping device is comprised of a first arm, a second arm, and a spring.

20. The welding accessory kit of claim 18 wherein said first wheel is rotatably attached to and extends beyond said first arm and said second wheel is rotatably attached to and extends beyond said second arm.
